(19) United States
(12) Patent Application Publication
(10) Pub. No.: US 2013/0285991 A1
(43) Pub. Date: Oct. 31, 2013

(54) LCD Driving Module, LCD Device and Driving Method

(71) Applicant: Yinhung Chen, Shenzhen (CN)

(72) Inventor: Yinhung Chen, Shenzhen (CN)

(21) Appl. No.: 13/515,282

(22) PCT Filed: Apr. 27, 2012
(86) PCT No.: PCT/CN12/74804

§ 371 Date: Jun. 11, 2012

(30) Foreign Application Priority Data
Apr. 26, 2012 (CN) 201210125593.5

(51) Int. Cl. G09G 5/00; G09G 3/36

(52) U.S. Cl. 345/204; 345/87

(57) ABSTRACT

The invention provides an LCD driving module, an LCD device, and a driving method. The LCD driving module of an LCD panel includes a data driving module(s), and a TCON; the data driving module is provided with a data interface connected with the TCON, the data driving module is internally integrated with a digital Vcom submodule, the input end of the digital Vcom submodule is connected to the data interface, and the output end of the digital Vcom submodule is connected to a common line. In the invention, a digital Vcom IC is not required to be arranged on the PCB, thereby reducing circuits, and saving PCB space. The integrated Vcom submodule is digitally regulated by the TCON, thereby obtaining high adjusting accuracy.

### TECHNICAL FIELD

The invention relates to the field of liquid crystal displays (LCDs), and more particularly to an LCD driving module, an LCD device, and a driving method.

### BACKGROUND

In an LCD driving structure, each pixel capacitor is generally in parallel connection with a storage capacitor to supply power to the pixel capacitor in the scanning period of one frame, so as to maintain the current pixel display. One end of the storage capacitor is connected with one end of the pixel capacitor, and the other end of the storage capacitor is connected to a common voltage (Vcom). There are two methods for adjusting Vcom: one method is that the Vcom is adjusted by a variable resistor, and the other method is that the Vcom is adjusted by inputting a digital signal from the outside by a digital Vcom IC. The first method requires that the variable resistor is manually rotated by a person using an adjusting bar to visually adjust, and the method has large variability so that the Vcom of each part cannot be in optimal value. The second method requires that a digital Vcom IC is put on a C/B PCB, thereby occupying some area.

### SUMMARY

In view of the above-described problems, the aim of the invention is to provide an LCD driving module, an LCD device, and a driving method thereof with the advantages of high adjusting accuracy and small occupied area.

The aim of the invention is achieved by the following technical scheme.

An LCD driving module of an LCD panel comprises data driving module(s) and a timing control circuit (TCON); the data driving module is provided with a data interface connected with the TCON, the data driving module is internally integrated with a digital Vcom submodule, an input end of the digital Vcom submodule is connected to the data interface, and an output end of the digital Vcom submodule is connected to a common line of the LCD panel.

Preferably, the data driving module is internally provided with an independent operation amplifier(s) (OP), an output signal of the digital Vcom submodule is connected to the common line by the OP(s). The original data driving module is provided with an inlet OP and an outlet OP, and each OP is provided with two pins. The invention takes full advantage of the OP resources of the original data driving module to connect the output end of the data driving module to the common line, thereby reducing the number of pins.

Preferably, the number of the data driving module(s) is at least two, and each data driving module is internally provided with two independent OPs; the number of the common line(s) is at least two, and each OP is connected with a nearest common line. The display quality is improved by employing multiple common lines in different zones to control, and each common line is required to be connected with one OP. In the invention, a plurality of data driving modules are arranged in parallel, to independently control each common line.

Preferably, the data interface is a differential data interface. This is a specific data interface form. The data transmission errors can be reduced by using the differential data interface.

An LCD device comprises an LCD driving module of an LCD panel mentioned above.

An LCD driving method comprises the following steps:

A: The TCON transmits the original data comprising the Vcom to the data driving module integrated with the digital Vcom submodule through a uniform data interface; and

B: The data driving module(s) outputs Vcom to the corresponding common line(s).

Preferably, in the step A, the number of the data driving module(s) is at least two, and each data driving module is internally provided with two independent OPs; the number of the common line(s) is at least two, and each OP is connected with a common line nearby. The TCON respectively transmits the original data to each data driving module in sequence. The display quality is improved by employing multiple common lines in different zones to control, and each common line is required to be connected with one OP. In the invention, a plurality of data driving modules are arranged in parallel, to independently control each common line. The original data is transmitted to each data driving module in sequence, thereby reducing data volume of each data command, and reducing the pressure of transmitting and receiving data.

Preferably, in the step A, the original data comprises a reset bit and a data bit; the data bit comprises Vcom data and display data in sequence. This is a specific data format of the original data.

Preferably, the number of the data driving module(s) is at least two. In the step A, the data bit comprises the Vcom data and display data of each data driving module in sequence. Such a data can comprise all the display data and Vcom data, thereby simplifying data structures. Furthermore, each data driving module can identify respective data segments from one command, thereby accelerating response speed.

Preferably, the LCD driving method further comprises the following step before the step A: the TCON comprises an I²C interface, and the original data is transmitted to the TCON by the I²C interface. This is a specific transmission method of the original data. The Vcom can be programmed from external, and the Vcom data can be freely adjusted, thereby broadening the application range.

In the invention, because the digital Vcom DAC is integrated into a data driving module (source driver), and then is connected to the TCON by a uniform data interface, the Vcom can be modified at any time by a command of the original data given by the TCON. Because the digital Vcom submodule is integrated into a data driving module, a digital Vcom IC is not required to be arranged on the printed circuit board (PCB), thereby reducing circuits, and saving PCB space. If the C, X separated design is used, the number of the Vcom routes of a flexible flat cable connector (FFC connector) can be reduced. The integrated Vcom submodule is digitally regulated by the TCON, thereby obtaining high adjusting accuracy.

### BRIEF DESCRIPTION OF FIGURES

FIG. 1 is a schematic diagram of a conventional data driving module;

FIG. 2 is a schematic diagram of a data driving module of an example of the invention;

FIG. 3 is a schematic diagram of the invention applied to an LCD panel;

FIG. 4 is a schematic diagram of a data format of the invention; and

FIG. 5 is a schematic diagram of a Vcom adjusted by an external command.

### DETAILED DESCRIPTION

The invention will further be described in detail in accordance with the figures and the preferable examples.

An LCD device comprises an LCD panel, and a backlight module; the LCD panel employing thin film transistor(s) (TFT) comprises scan lines and data lines which are crisscross arranged. A source electrode of the TFT is connected with a data line(s), a gate electrode of the TFT is connected with a scan line(s), and a drain electrode of the TFT is connected with a pixel capacitor. Both ends of the pixel capacitor are generally in parallel connection with a storage capacitor to supply voltage to the pixel capacitor in the signal period of one frame, so as to maintain the deflection of liquid crystal molecules in the pixel capacitor and ensure complete image display. One end of the storage capacitor is connected with the pixel capacitor, and the other end of the storage capacitor is connected with a Vcom as a reference voltage. The Vcom can be one or multiple to be controlled in different zones so as to improve the display effect. The Vcom is generally achieved in a form of common line(s).

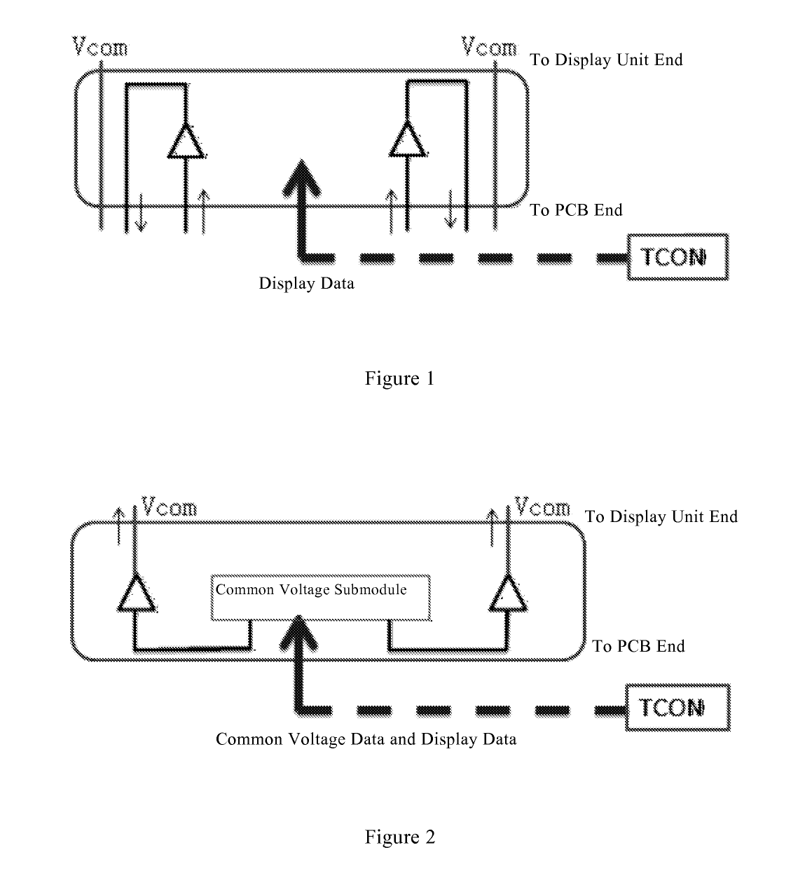

As shown in FIG. 2, the embodiment comprises data driving module(s) for controlling data lines, and a TCON; the data driving module is provided with a data interface connected with the TCON, the data driving module is internally integrated with a digital Vcom submodule, the input end of the digital Vcom submodule is connected to the data interface, and the output end of the digital Vcom submodule is connected to a common line of the LCD panel. The data interface is a differential data interface.

The data driving module is internally provided with an independent OP(s), and an output signal of the digital Vcom submodule is connected to the common line by the OP(s). The original data driving module is provided with an inlet OP and an outlet OP, and each OP is provided with two pins. The invention takes full advantage of the OP resources of the original data driving module to connect the output end of the data driving module to the common line, thereby reducing the number of pins.

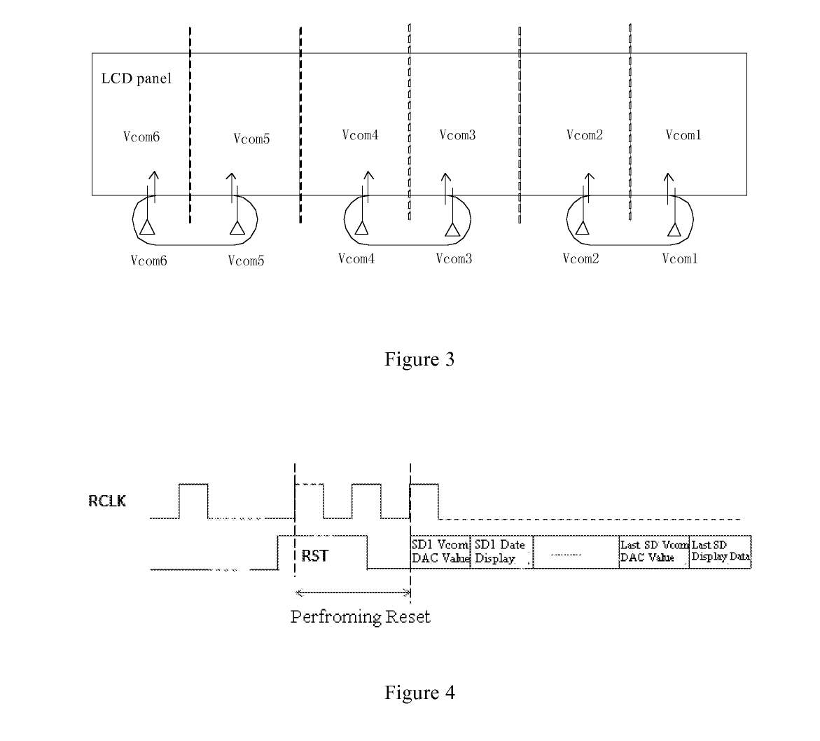

As shown in FIG. 3, in the occasion of multiple Vcoms, a plurality of data driving modules are arranged, and each data driving module is internally provided with two independent OPs. Correspondingly, the number of the common line(s) is multiple, and each OP is connected with a nearest common line. The display quality is improved by employing multiple common lines in different zones to control, and each common line is required to be connected with an OP. In the invention, a plurality of data driving modules can be arranged in parallel, to independently control each common line.

An LCD driving method mentioned above comprises the following steps:

A: The TCON transmits the original data comprising Vcom to the data driving module integrated with digital Vcom submodule through a uniform data interface.

In the occasion of multiple Vcom, a plurality of data driving modules are arranged, and each data driving module is internally provided with two independent OPs. Correspondingly, the number of the common line(s) is multiple, and each OP is connected with a nearest common line. The display quality is improved by employing multiple common lines in different zones to control, and each common line is required to be connected with an OP. In the invention, a plurality of data driving modules can be arranged in parallel, to independently control each common line. The original data is transmitted to each data driving module in sequence, thereby reducing the data volume of each data command, and reducing the pressure of transmitting and receiving data.

As shown in FIG. 4, the original data comprises a reset bit, and a data bit; the data bit comprises Vcom data and display data in sequence. If the number of the data driving module(s) is multiple, the data bit comprises the Vcom data and the display data of each data driving module in sequence, namely from the first data driving module SD1 to the last data driving module (Last SD).

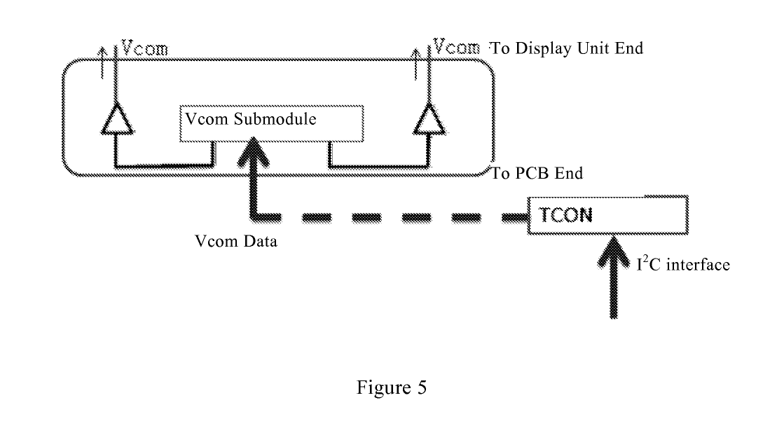

As shown in FIG. 5, if the Vcom is adjusted from the outside, a command is given by the original I²C interface of the TCON, and the Vcom data (Vcom DAC) value is output to the data driving module (source driver) by the TCON.

B: The data driving module(s) outputs Vcom to corresponding common line(s).

In the invention, because the digital Vcom DAC is integrated into a data driving module (source driver), and then is connected to the timing control circuit (TCON) by a uniform data interface, the Vcom can be modified at any time by giving a command of the original data through the TCON. Because the digital Vcom DAC is integrated into a data driving module, a digital Vcom IC is not required to be arranged on the PCB, thereby reducing circuits, and saving PCB space. If the C, X separated design is used, the Vcom routes of a FFC connector can be reduced. The integrated Vcom DAC is digitally regulated by the TCON, thereby having high adjusting accuracy.

A Vcom submodule is added between the two inner OPs of the original data driving module (source driver), the output and input ends of the OPs are not required to be arranged at both ends of the PCB, and the output end of the new OP is connected to the end from the original Vcom route to the LCD panel (cell), thereby reducing the number of pins to the end of the PCB. For the application of Multi-Vcom lines, the Vcom of the LCD panel (cell) have different required voltages because of different zones. The lines can be directly input into the LCD panel (cell) nearby, to provide Vcom DAC value through the TCON. Thus, after performing reset (RST), the original differential data line (differential data pair) provides the Vcom DAC value and display data value of the SD1, and then the SD2 receives the values, up to the last SD (source driver). Because the number of Vcom DAC values is few, the data volume will not be added too much. If externally adjusting the voltage, a command is given by the original I²C interface using the TCON, and the Vcom DAC value is output to the data driving module (source driver) by the TCON. Because the data driving module (source driver) is internally provided with Vcom submodule, the digital Vcom IC arranged on the C/B can be omitted; and because the command is given by the TCON, the Vcom can be modified at any time, and can be conveniently applied to the LCD panel of the Multi-Vcom lines.

In the invention, the function of the digital Vcom DAC is integrated into a data driving module (source driver), a digital Vcom IC is not required to be arranged on the C/B, thereby reducing circuits, and saving PCB space. If the C, X separated design is used, the common line routes of the FFC connectors can be reduced.

If one COF is provided with two build-in OPs, four pins are required at the ends of the PCB to perform output and input. In the design, the four pins are omitted, and the output end of each OP is connected to the COF route of the original common line.

Because each data driving module is provided with independent OPs for common line output, if the LCD panel (cell) is provided with multiple common lines, the input nearby is performed, and voltages are respectively applied.

The Vcom DAC value is changed by a command given by the TCON through the original differential data line (differential data pair) without additional lines. Because the TCON is originally reserved with an I²C interface to the outside, if the Vcom is externally adjusted, a command is given to the TCON, and then the TCON outputs a Vcom value.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD driving module of an LCD panel, comprising: data driving module(s), and a TCON; wherein said data driving module is provided with a data interface connected with said TCON, said data driving module is internally integrated with a digital Vcom submodule, the input end of said digital Vcom submodule is connected to said data interface, and the output end of said digital Vcom submodule is connected to a common line of said LCD panel.

2. The LCD driving module of an LCD panel of claim 1, wherein said data driving module is internally provided with an independent OP(s), an output signal of said digital Vcom submodule is connected to said common line by said OP(s).

3. The LCD driving module of an LCD panel of claim 2, wherein the number of said data driving module(s) is at least two, and each said data driving module is internally provided with two independent OPs; the number of said common line(s) is at least two, and each said OP is connected with a common line nearby.

4. The LCD driving module of an LCD panel of claim 1, wherein said data interface is a differential data interface.

5. An LCD device, comprising an LCD driving module of an LCD panel, wherein said LCD driving module of an LCD panel comprises data driving module(s), and a TCON; said data driving module is provided with a data interface connected with said TCON, said data driving module is internally integrated with a digital Vcom submodule, the input end of said digital Vcom submodule is connected to said data interface, and the output end of said digital Vcom submodule is connected to a common line of said LCD panel.

6. The LCD device of claim 5, wherein said data driving module is internally provided with an independent OP(s), and an output signal of said digital Vcom submodule is connected to said common line by said OP(s).

7. The LCD device of claim 6, wherein the number of said data driving module(s) is at least two, and each said data driving module is internally provided with two independent OPs; the number of said common line(s) is at least two, and each said OP is connected with a common line nearby.

8. The LCD device of claim 5, wherein said data interface is a differential data interface.

9. An LCD driving method, comprising: the following steps:
A: a TCON transmits the original data comprising Vcom to a data driving module integrated with digital Vcom submodule through a uniform data interface; and
B: said data driving module outputs Vcom to a corresponding common line.

10. The LCD driving method of claim 9, wherein in said step A, the number of said data driving module(s) is at least two, and each said data driving module is internally provided with two independent OPs; the number of said common line(s) is at least two, and each OP is connected with a nearest common line; said TCON respectively transmits the original data to each said data driving module in sequence.

11. The LCD driving method of claim 9, wherein in the step A, said original data comprises a reset bit, and a data bit; said data bit comprises display data and Vcom data in sequence.

12. The LCD driving method of claim 11, wherein the number of said data driving module(s) is at least two, and in said step A, said data bit comprises the Vcom data and display data of each said data driving module in sequence.

13. The LCD driving method of claim 9, wherein said LCD driving method further comprises the following step before said step A: said TCON comprises an I²C interface, and said original data is transmitted to said TCON through said I²C interface.
